(19) United States
(12) Patent Application Publication
(10) Pub. No.: US 2025/0096910 A1
(43) Pub. Date: Mar. 20, 2025

(54) METHOD AND APPARATUS FOR PERFORMING SINGULARITY DETECTION AIDED CALIBRATION ON TIME-INTERLEAVED ANALOG-TO-DIGITAL CONVERTER

(71) Applicant: MEDIATEK INC., Hsinchu City (TW)

(72) Inventors: Yun-Han Pan, Hsinchu City (TW); Chien-Hung Chiang, Hsinchu City (TW); Gabriele Manganaro, San Jose, CA (US)

(73) Assignee: MEDIATEK INC., Hsinchu City (TW)

(21) Appl. No.: 18/890,768

(22) Filed: Sep. 20, 2024

Related U.S. Application Data
(60) Provisional application No. 63/583,874, filed on Sep. 20, 2023.

(51) Int. Cl. H04B 17/11

(52) U.S. Cl. CPC H04B 17/11

(57) ABSTRACT

A calibration apparatus includes a calibration circuit and a singularity detection (SD) circuit. The calibration circuit performs a calibration process upon a time-interleaved analog-to-digital converter (TI-ADC) with a plurality of TI channels, wherein the calibration process includes detecting and correcting mismatch between different TI channels of the TI-ADC. The SD circuit sets an SD flag by evaluating variation of statistical characteristics of an ADC input signal between different TI channels of the TI-ADC, and outputs the SD flag to the calibration circuit, wherein the calibration circuit controls the calibration process according to the SD flag.

### CROSS REFERENCE TO RELATED APPLICATIONS

This application claims the benefit of U.S. Provisional Application No. 63/583,874, filed on Sep. 20, 2023. The content of the application is incorporated herein by reference.

### BACKGROUND

The present invention relates to analog-to-digital conversion, and more particularly, to a method and apparatus for performing singularity detection aided calibration on a time-interleaved analog-to-digital converter (TI-ADC).

High-speed analog-to-digital conversion is the key part for waveform digitization in a variety of applications, such as wireless communication systems. For high-speed waveform digitization, the time-interleaved analog-to-digital converter (TI-ADC) is a well-known technology to achieve higher sample rate through parallelism. The idea of a TI-ADC is that each of parallel TI channels (i.e., sub-ADC channels) alternately takes one sample, and all samples are merged into one sequence in a digital domain. Thus, sampling with a TI-ADC with multiple TI channels is equivalent to sampling with an ADC with a higher sampling rate. However, the mismatches, including gain mismatch and skew mismatch, among all TI channels of the TI-ADC decrease the performance of spurious free dynamic range (SFDR). To address this issue, mismatch correction has been widely incorporated into the TI-ADC system. For example, the mismatch correction methods may include an analog correction method and a digital correction method. The mismatch correction depends on mismatches (e.g., gain mismatch and skew mismatch) that are detected using a mismatch detection algorithm. When there is particular relationship between a sampling rate of the TI-ADC and an input frequency of an ADC input signal (i.e., an analog waveform signal received by the TI-ADC), the mismatch detection algorithm may fail to work properly, resulting in calibration divergence and SFDR degradation at the input frequency (also called singularity frequency). Specifically, the class of ADC input signals that leads to a singularity condition leading the calibration to failure is called non-modulo M quasi-stationary inputs. Thus, there is a need for an innovative low-complexity, low-cost, high-performance singularity detection scheme for detecting occurrence of a singularity case and enhancing the robustness of calibration of the TI-ADC.

### SUMMARY

One of the objectives of the claimed invention is to provide a method and apparatus for performing singularity detection aided calibration on a TI-ADC.

According to a first aspect of the present invention, an exemplary calibration apparatus is disclosed. The exemplary calibration apparatus includes a calibration circuit and a singularity detection (SD) circuit. The calibration circuit is arranged to perform a calibration process upon a TI-ADC with a plurality of TI channels, wherein the calibration process comprises detecting and correcting mismatch between different TI channels of the TI-ADC. The SD circuit is arranged to set an SD flag by evaluating variation of statistical characteristics of an ADC input signal between different TI channels of the TI-ADC, and output the SD flag to the calibration circuit, wherein the calibration circuit is further arranged to control the calibration process according to the SD flag.

According to a second aspect of the present invention, an exemplary calibration method is disclosed. The exemplary calibration method includes: performing a calibration process upon a TI-ADC with a plurality of TI channels, comprising detecting and correcting mismatch between different TI channels of the TI-ADC; setting an SD flag by evaluating variation of statistical characteristics of an ADC input signal between different TI channels of the TI-ADC; and controlling the calibration process according to the SD flag.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an analog-to-digital conversion system according to an embodiment of the present invention.

FIG. 2 is a diagram illustrating a time-domain sampling operation performed by a TI-ADC under a normal case.

FIG. 3 is a diagram illustrating a time-domain sampling operation performed by a TI-ADC under a singularity case.

FIG. 4 is a diagram illustrating autocorrelation functions of different TI channels under a normal case.

FIG. 5 is a diagram illustrating autocorrelation functions of different TI channels under a singularity case.

FIG. 6 is a diagram illustrating a small peak-to-peak value of autocorrelation at the origin under a normal case.

FIG. 7 is a diagram illustrating a large peak-to-peak value of autocorrelation at the origin under a singularity case.

FIG. 8 is a diagram illustrating a first singularity detection circuit according to an embodiment of the present invention.

FIG. 9 is a diagram illustrating a second singularity detection circuit according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

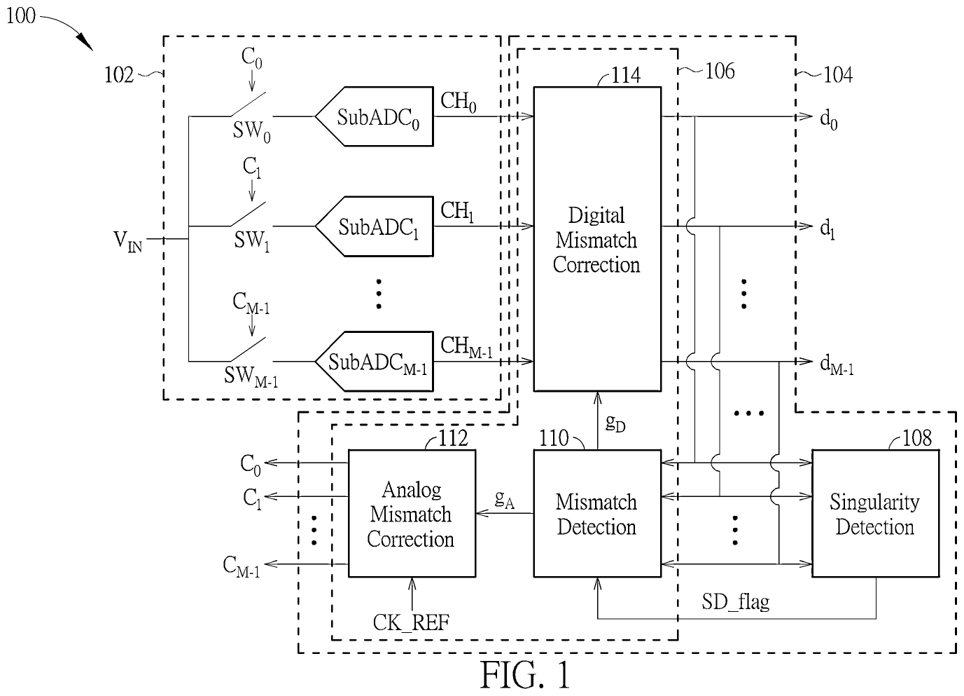

FIG. 1 is a diagram illustrating an analog-to-digital conversion system according to an embodiment of the present invention. For example, the analog-to-digital conversion system 100 may be employed by a receiver of a wireless communication system. In practice, any application using the analog-to-digital conversion system 100 that performs TI-ADC calibration with the aid of the proposed singularity detection scheme falls within the scope of the present invention. Specifically, the proposed singularity detection scheme is intended to detect occurrence of a singularity case (e.g., a particular case where a TI-ADC input signal is a non-modulo M quasi-stationary input). Hence, the term “singularity detection” mentioned hereinafter may be referred to as detection of a specific type of TI-ADC input signals (e.g., non-modulo M quasi-stationary inputs) that leads to a singularity condition for the auto-correlation calibration used by the blind calibration process. In other words, the terms “singularity detection” and “non-modulo M quasi-stationary input detection” may be interchangeable.

The analog-to-digital conversion system 100 includes a TI-ADC 102 and a calibration apparatus 104. The TI-ADC 102 includes a plurality of TI channels (i.e., sub-ADC channels) CH₀, CH₁, . . . , CH_{M-1} (M≥2). During a calibration process, the received signal of the receiver may act an ADC input signal V_{IN} of the TI-ADC 102. The ADC input signal V_{IN} is distributed to a plurality of sub-ADCs (labeled by “SubADC₀”, “SubADC₁”, . . . , “SubADC_{M-1}”) through a plurality of switches (labeled by “SW₀”, “SW₁”, . . . , “SW_{M-1}”) under control of a plurality of clock signals C₀, C₁, . . . , C_{M-1} having the same frequency but different phases.

The calibration apparatus 104 includes a calibration circuit 106 and a singularity detection circuit (labeled by “singularity detection”) 108. The calibration circuit 106 is arranged to perform a calibration process upon the TI-ADC 102. The calibration process may include detecting and correcting mismatch (e.g., gain mismatch and skew mismatch) between different TI channels CH₀-CH_{M-1} of the TI-ADC 102. For example, the calibration process may be a blind calibration process (i.e., a calibration process without knowledge of the ADC input signal). Specifically, the blind calibration process operates under a condition that the ADC input signal V_{IN} of the TI-ADC 102 is not a pre-defined analog signal with a known waveform, but it needs to extract the statistical characteristic of the ADC input signal V_{IN} for detecting mismatch (e.g., gain mismatch and skew mismatch) between different TI channels CH₀-CH_{M-1} of the TI-ADC 102.

In this embodiment, the calibration circuit 106 includes a mismatch detection circuit (labeled by “mismatch detection”) 110, an analog mismatch correction circuit (labeled by “analog mismatch correction”) 112, and a digital mismatch correction circuit (labeled by “digital mismatch correction”) 114. The mismatch detection circuit 110 is arranged to detect mismatch (e.g., gain mismatch and skew mismatch) between different TI channels CH₀-CH_{M-1} of the TI-ADC 102, apply analog correction gear control g_{A} to the analog mismatch correction circuit 112, and apply digital correction gear control g_{D} to the digital mismatch correction circuit 114. The analog mismatch correction circuit 112 is arranged to deal with analog mismatch correction. For example, the analog mismatch correction circuit 112 may adjust delay amounts applied to the reference clock signal CK_REF, where the clock signals C₀-C_{M-1} with different phases are derived from the same reference clock signal CK_REF. The digital mismatch correction circuit 114 is arranged to deal with digital mismatch correction. For example, the digital mismatch correction circuit 114 may apply post-processing to ADC output signals d₀, d₁, . . . , d_{M-1} of the TI channels CH₀-CH_{M-1}. Since principles of the blind calibration are known to those skilled in the art and the present invention is focused on the singularity detection design, further description of the calibration circuit 106 is omitted here for brevity.

The present invention proposes a low-complexity, low-cost, high-performance singularity detection scheme for detecting occurrence of a singularity case and enhancing the robustness of TI-ADC calibration. In this embodiment, the singularity detection circuit 108 is arranged to set a singularity detection (SD) flag SD flag by evaluating variation of statistical characteristics of the ADC input signal V_{IN} between different TI channels CH₀-CH_{M-1} of the TI-ADC 102, and output the SD flag SD_flag to the calibration circuit 106 (particularly, mismatch detection circuit 110 of calibration circuit 106). The calibration circuit 106 (particularly, mismatch detection circuit 110 of calibration circuit 106) is further arranged to control the calibration process (e.g., blind calibration process) according to the SD flag SD_flag. For example, the SD flag SD flag determines whether the calibration circuit 106 (particularly, mismatch detection circuit 110 of calibration circuit 106) should interrupt the calibration process by stopping updating the signal statistical characteristic extraction for the ADC input signal V_{IN}.

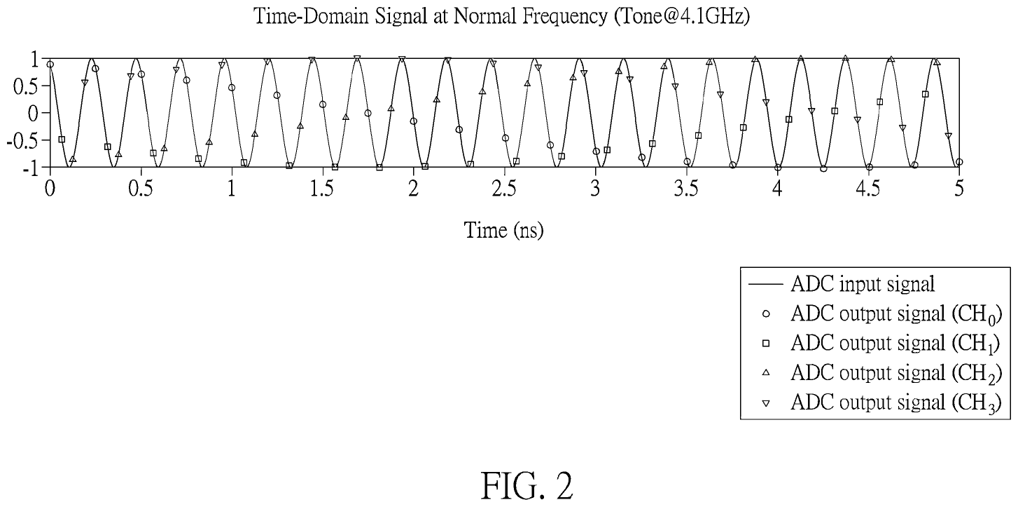

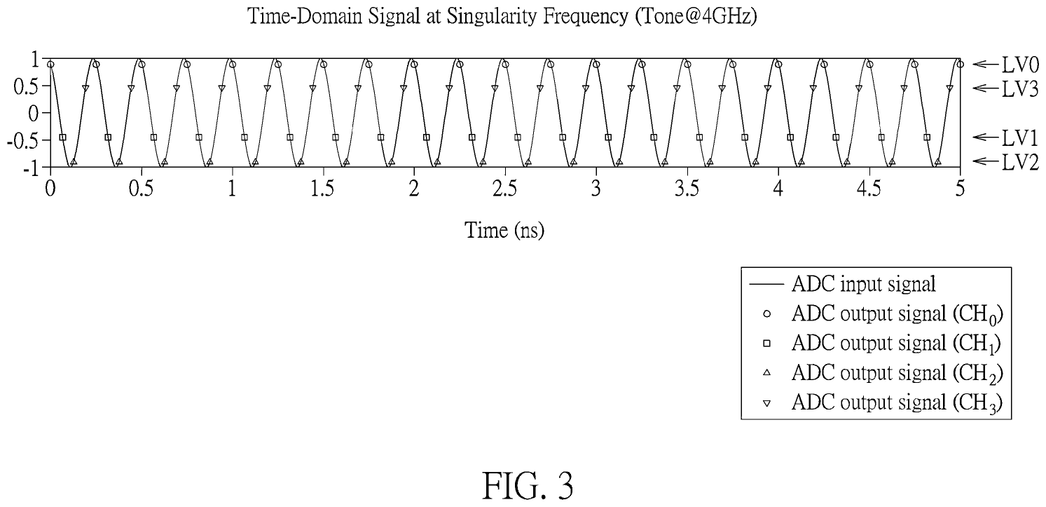

The proposed singularity detection scheme is based on variation of statistical characteristics of the ADC input signal V_{IN} between different TI channels CH₀-CH_{M-1} of the TI-ADC 102. Please refer to FIG. 2 in conjunction with FIG. 3. FIG. 2 is a diagram illustrating a time-domain sampling operation performed by the TI-ADC 102 under a normal case. FIG. 3 is a diagram illustrating a time-domain sampling operation performed by the TI-ADC 102 under a singularity case. Suppose that the TI-ADC 102 has four TI channels CH₀, CH₁, CH₂, CH₃ (M=4), and the sampling rate of the TI-ADC 102 is 16 GHz. When the ADC input signal V_{IN} is a time-domain signal at a normal frequency (e.g., a single tone at 4.1 GHz), the sampling rate and the input frequency do not have particular relationship that leads to a singularity case. Hence, regarding an ADC output signal of each TI channel, ADC samples obtained from the ADC input signal V_{IN} have different sample values, and can better track the waveform of the ADC input signal V_{IN} over time. In a case where there is no gain mismatch between different TI channels, a mean power value of the ADC samples obtained at one TI channel is equal to a mean power value of the ADC samples obtained at a different TI channel. However, when the ADC input signal V_{IN} is a time-domain signal at a singularity frequency (e.g., a single tone at 4 GHz), the sampling rate and the input frequency have particular relationship that leads to a singularity case. Hence, regarding an ADC output signal of each TI channel, ADC samples obtained from the ADC input signal V_{IN} have the same sample value, and fail to track the waveform of the ADC input signal V_{IN} over time. In a case where there is no gain mismatch between different TI channels, a mean power value LV0² of the ADC samples obtained at TI channel CH₀, a mean power value LV1² of the ADC samples obtained at TI channel CH₁, a mean power value LV2² of the ADC samples obtained at TI channel CH₂, and a mean power value LV3² of the ADC samples obtained at TI channel CH₃ are different from each other. The autocorrelation-based blind calibration algorithm misjudges that there is gain mismatch between different TI channels, and will diverge under the singularity case. Since the ADC samples are not random enough at some specific input frequencies (singularity case), the autocorrelation-based blind calibration algorithm is unable to estimate correct autocorrelation for gain mismatch detection and skew calibration detection, and may induce a large calibration bias.

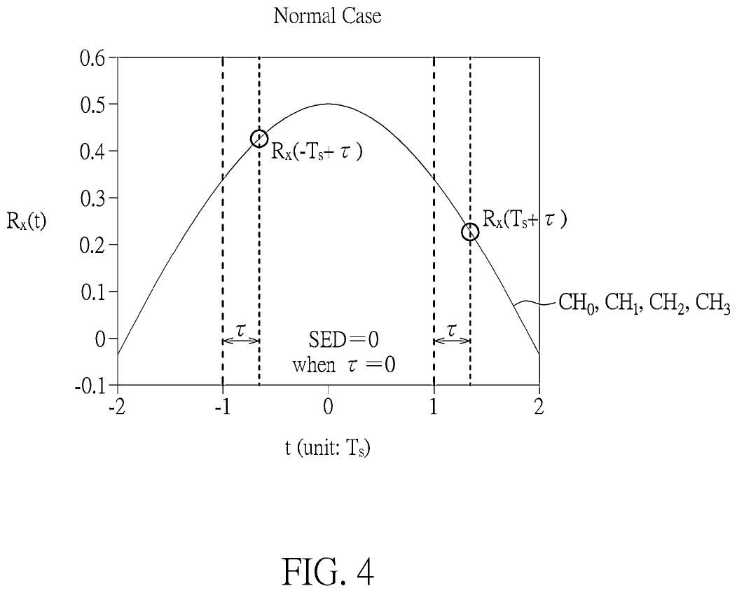

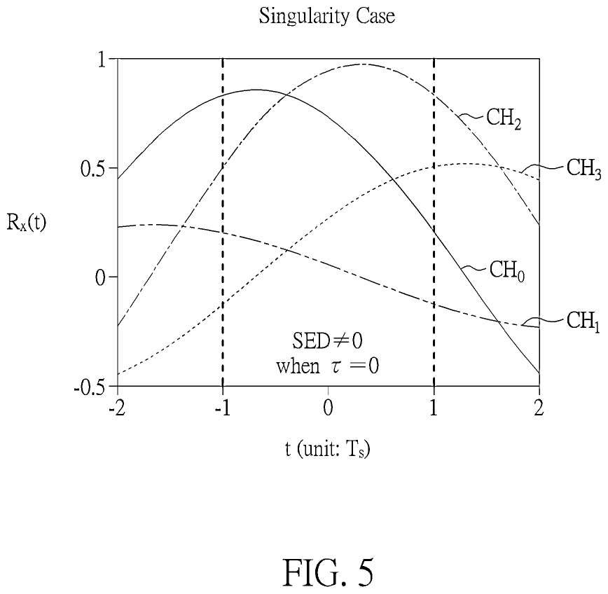

Please refer to FIG. 4 in conjunction with FIG. 5. FIG. 4 is a diagram illustrating autocorrelation functions Rₓ(t) of different TI channels CH₀-CH₃ (M=4) under a normal case. FIG. 5 is a diagram illustrating autocorrelation functions Rₓ(t) of different TI channels CH₀-CH₃ (M=4) under a singularity case. As mentioned above, the ADC samples are random enough for an ADC input signal with a normal frequency (normal case). Hence, autocorrelation functions Rₓ(t) of different TI channels CH₀-CH₃ may be very close to each other under the normal case. The skew error detection (SED) of the blind calibration is an indicator of skew mismatch, and can be expressed by SED=Rₓ(−Tₛ+τ)−Rₓ(Tₛ+τ), where Tₛ is the sampling period. When there is no skew mismatch (i.e., τ=0), the SED output will be a zero value under the normal case, which correctly indicates there is no skew mismatch. However, the ADC samples are not random enough for an ADC input signal with a singularity frequency (singularity case). Hence, autocorrelation functions Rₓ(t) of different TI channels CH₀-CH₃ may diverge significantly under the singularity case. In addition, when there is no skew mismatch (i.e., τ=0), the SED output will be a non-zero value under the singularity case, which misjudges and indicates there is skew mismatch.

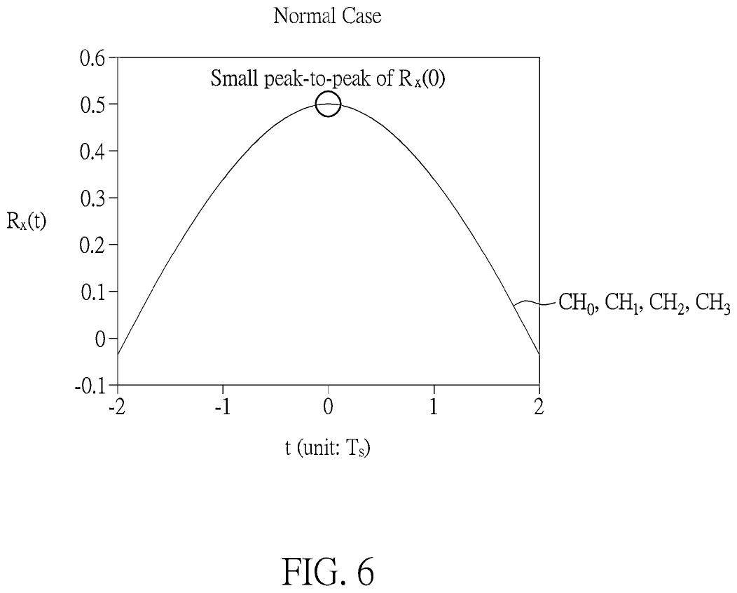

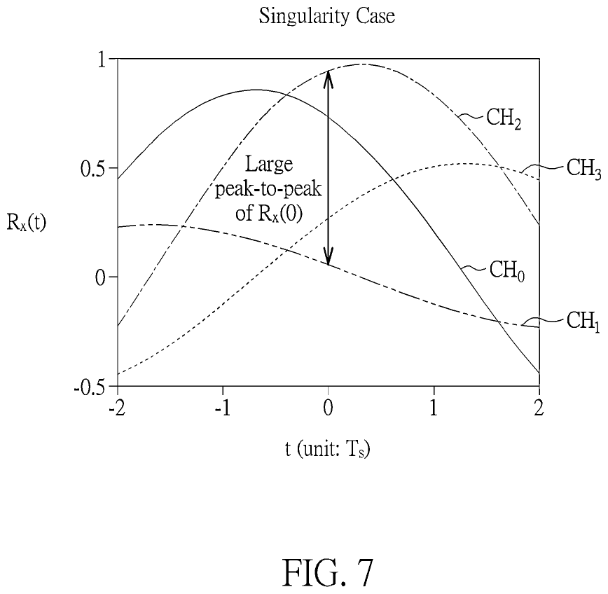

Based on above observations, the proposed singularity detection scheme detects occurrence of the singularity case by evaluating variation of statistical characteristics of the ADC input signal V_{IN} between different TI channels CH₀-CH_{M-1} of the TI-ADC 102. For example, the proposed singularity detection scheme may check the autocorrelation functions Rₓ(t) of all TI channels CH₀-CH_{M-1} of the TI-ADC 102 to detect occurrence of the singularity case. In some embodiments of the present invention, the autocorrelation function Rₓ(t) at the origin (t=0) (i.e., mean power Rₓ(0)) is adopted to determine whether the ADC input signal V_{IN} is at a singularity frequency. Please refer to FIG. 6 in conjunction with FIG. 7. FIG. 6 is a diagram illustrating a small peak-to-peak value of autocorrelation at the origin Rₓ(0) under a normal case. FIG. 7 is a diagram illustrating a large peak-to-peak value of autocorrelation at the origin Rₓ(0) under a singularity case. Since the autocorrelation functions Rₓ(t) of different TI channels do not diverge under the normal case, there is a small peak-to-peak value among Rₓ(0) of different TI channels CH₀-CH₃ (M=4). However, since the autocorrelation functions Rₓ(t) of different TI channels diverge under the singularity case, there is a large peak-to-peak value among Rₓ(0) of different TI channels CH₀-CH₃ (M=4). Hence, a peak-to-peak value (i.e., a largest difference value) found from statistical characteristics of the ADC input signal V_{IN} between different TI channels CH₀-CH_{M-1} of the TI-ADC 102 can be used to determine if the ADC input signal V_{IN} is at one of specific input frequencies (singularity frequencies) under the current sampling rate setting of the TI-ADC 102.

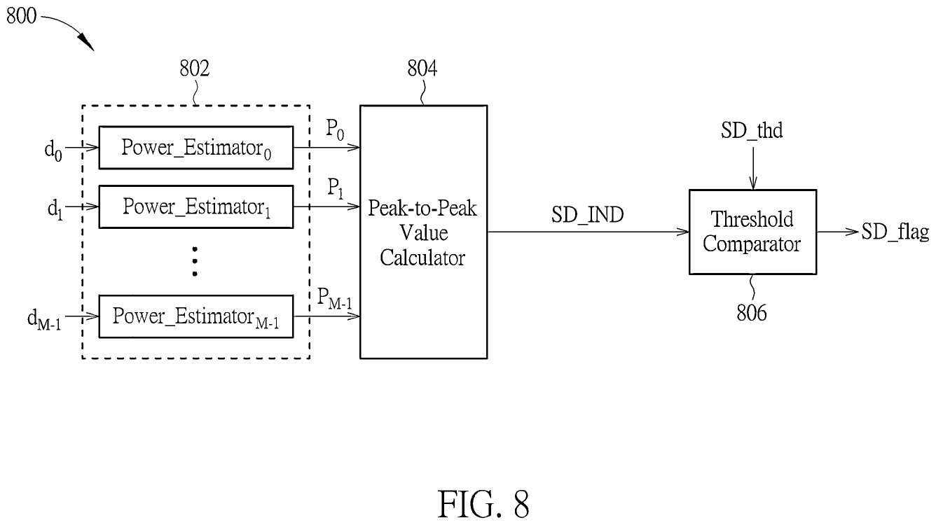

FIG. 8 is a diagram illustrating a first singularity detection circuit according to an embodiment of the present invention. The singularity detection circuit 108 shown in FIG. 1 may be implemented using the singularity detection circuit 800 shown in FIG. 8. The singularity detection circuit 800 includes a power estimation circuit 802, a peak-to-peak value calculation circuit (labeled by “peak-to-peak value calculator”) 804, and a comparator circuit (labeled by “threshold comparator”) 806. The power estimation circuit 802 includes a plurality of power estimators (labeled by “power_estimator₀”, “power_estimator₁”, . . . , “power_estimator_{M-1}”. The power estimation circuit 802 is arranged to receive ADC output signals d₀-d_{M-1} (which are digital signals derived from outputs of TI channels CH₀-CH_{M-1}, respectively), and estimate a plurality of power indication values P₀, P₁, . . . , P_{M-1} according to the ADC output signals d₀-d_{M-1}, respectively. The power indication value Pᵢ is indicative of a statistical characteristic of a sequence of digital values included in the i^{th} ADC output signal d₁, where i={0, 1, . . . , M-1}. For example, each of the power indication values P₀-P_{M-1} may be a mean power value (e.g., autocorrelation at the origin Rₓ(0)) calculated for a corresponding ADC output signal. For another example, each of the power indication values P₀-P_{M-1} may be a mean absolute value (i.e., an average of absolute values of a sequence of digital values included in one ADC output signal).

The peak-to-peak value calculation circuit 804 is arranged to perform a peak-to-peak value calculation operation according to the power indication values P₀-P_{M-1} output from the power estimation circuit 802. For example, a maximum among all possible difference values, each obtained from two of the power indication values P₀, P₁, . . . , P_{M-1} (e.g., |Pᵢ-Pⱼ|, where i≠j, and i,j={0,1, . . . ,M-1}), is selected as an output of the peak-to-peak value calculation circuit 804. Hence, the peak-to-peak value calculation circuit 804 outputs a peak-to-peak value (i.e., largest difference value) as an SD indicator SD_IND.

The comparator circuit 806 is arranged to compare the SD indicator SD_IND (which is derived from an output of the peak-to-peak value calculation circuit 804) with a pre-defined threshold SD_thd to generate a comparison result, and set the SD flag SD_flag by the comparison result. The comparator circuit 806 uses the pre-defined threshold SD_thd to identify the SD indicator SD_IND as an indication of a normal case or an indication of a singularity case. For example, if the comparison result indicates that the SD indicator SD_IND exceeds the pre-defined threshold SD_thd (i.e., SD_IND>SD_thd), the SD flag SD flag is set by a first logic value (e.g., SD flag=1) to indicate a singularity case which has poor signal quality; and if the comparison result indicates that the SD indicator SD_IND does not exceed the pre-defined threshold SD_thd (i.e., SD_IND≤SD_thd), the SD flag SD_flag is set by a second logic value (e.g., SD_flag=0) to indicate a normal case which has good signal quality.

Regarding the singularity detection circuit 800 shown in FIG. 8, the peak-to-peak value calculation circuit 804 provides its output to the comparator circuit 806 directly. However, this is for illustrative purposes only, and is not meant to be a limitation of the present invention. In other embodiments of the present invention, additional circuit block(s) may be inserted between peak-to-peak value calculation circuit 804 and comparator circuit 806.

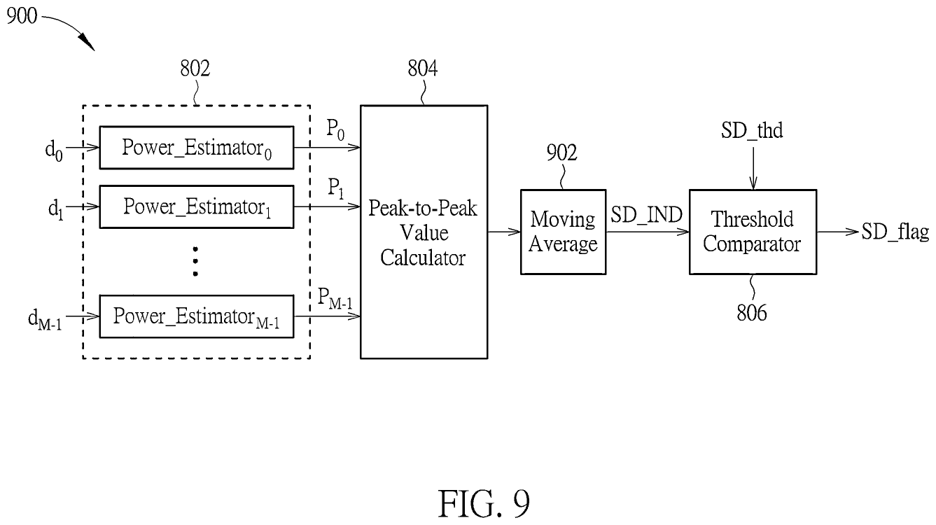

FIG. 9 is a diagram illustrating a second singularity detection circuit according to an embodiment of the present invention. The singularity detection circuit 108 shown in FIG. 1 may be implemented using the singularity detection circuit 900 shown in FIG. 9. The difference between the singularity detection circuits 800 and 900 is that the singularity detection circuit 900 further includes a moving average circuit (labeled by “moving average”) 902 coupled between the peak-to-peak value calculation circuit 804 and the comparator circuit 806. Since there is a strong correlation between the SD indicator and the SFDR performance, the present invention proposes applying a moving average function to the SD indicator for singularity detection stability enhancement. Hence, the moving average circuit 902 is arranged to calculate a moving average value according to the output of the peak-to-peak value calculation circuit 804, and output the moving average value as the SD indicator SD_IND. With the help of the moving average function, an abrupt change of the SD indicator SD_IND can be avoided to enhance the singularity detection stability.

As mentioned above, the calibration circuit 106 (particularly, mismatch detection circuit 110 of calibration circuit 106) is further arranged to control the calibration process (e.g., blind calibration process) according to the SD flag SD_flag. When the comparison result generated at the comparator circuit 806 indicates that the SD indicator SD_IND exceeds the pre-defined threshold SD_thd, the SD flag SD_flag (e.g., SD_flag=1) can be used to instruct the calibration circuit 106 to interrupt the calibration process (e.g., blind calibration process). For example, the mismatch detection circuit 110 may stop updating the signal statistical characteristic extraction for the ADC input signal V_{IN} during a period in which SD_flag=1. In this way, the gain mismatch detection and the skew mismatch detection are protected from being affected by divergence of autocorrelation functions of TI channels under the singularity case. Compared to a blind calibration process without protection provided by the proposed singularity detection scheme, a blind calibration process that is protected by the proposed singularity detection scheme can have better SFDR performance at specific input frequencies that are singularity frequencies.

When the comparison result generated at the comparator circuit 806 indicates that the SD indicator SD_IND does not exceed the pre-defined threshold SD_thd, the SD flag SD_flag (e.g., SD_flag=0) can be used to instruct the calibration circuit 106 to resume or continue the calibration process (e.g., blind calibration process).

The detection of the singularity case is based on variation of statistical characteristics of the ADC input signal V_{IN} between different TI channels CH₀-CH_{M-1} of the TI-ADC 102. In general, a peak-to-peak value at the singularity frequency is much larger than a peak-to-peak value resulting from gain mismatch between different TI channels. In some embodiments of the present invention, a foreground calibration may be performed to further improve the singularity detection accuracy in a following background calibration. During the foreground calibration, a known ADC input signal which is not located at any singularity frequency is generated as a calibration source signal, the singularity detection circuit 108 is disabled, and the calibration circuit 106 is enabled. After the gain mismatch and skew mismatch are corrected by the foreground calibration, the background calibration can be performed during normal operations of the analog-to-digital conversion system 100, where the ADC input signal V_{IN} may be a received signal of a receiver of a wireless communication system. During the background calibration, the singularity detection circuit 108 and the calibration circuit 106 are enabled, where the singularity detection circuit 108 stops the calibration process (e.g., updating the signal statistical characteristic extraction for the ADC input signal V_{IN} in the mismatch detection) at each detected singularity case to avoid divergence.

Since detection of the singularity case is based on variation of statistical characteristics of the ADC input signal V_{IN} between different TI channels CH₀-CH_{M-1} of the TI-ADC 102, there is no need of a histogram-based operation which requires a large buffer. Hence, the proposed singularity detection scheme has low hardware complexity and low cost. In addition, singularity cases and normal cases are well distinguished by the proposed singularity detection scheme even at an input frequency extremely close to a singularity frequency. Hence, the proposed singularity detection scheme also has high detection performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A calibration apparatus comprising:
a calibration circuit, arranged to perform a calibration process upon a time-interleaved analog-to-digital converter (TI-ADC) with a plurality of TI channels, wherein the calibration process comprises detecting and correcting mismatch between different TI channels of the TI-ADC; and
a singularity detection (SD) circuit, arranged to set an SD flag by evaluating variation of statistical characteristics of an ADC input signal between different TI channels of the TI-ADC, and output the SD flag to the calibration circuit, wherein the calibration circuit is further arranged to control the calibration process according to the SD flag.

2. The calibration apparatus of claim 1, wherein the calibration process is a blind calibration process.

3. The calibration apparatus of claim 1, wherein the SD circuit comprises:
a power estimation circuit, arranged to receive a plurality of digital signals derived from outputs of the plurality of TI channels, respectively, and estimate a plurality of power indication values according to the plurality of digital signals, respectively;
a peak-to-peak value calculation circuit, arranged to perform a peak-to-peak value calculation operation according to the plurality of power indication values; and
a comparator circuit, arranged to compare a pre-defined threshold with an SD indicator derived from an output of the peak-to-peak value calculation circuit to generate a comparison result, and set the SD flag according to the comparison result.

4. The calibration apparatus of claim 3, wherein each of the plurality of power indication values is a mean power value.

5. The calibration apparatus of claim 3, wherein each of the plurality of power indication values is a mean absolute value.

6. The calibration apparatus of claim 3, wherein the SD circuit further comprises:
a moving average circuit, coupled between the peak-to-peak value calculation circuit and the comparator circuit, wherein the moving average circuit is arranged to calculate a moving average value according to the output of the peak-to-peak value calculation circuit, and outputs the moving average value as the SD indicator.

7. The calibration apparatus of claim 3, wherein when the comparison result indicates that the SD indicator exceeds the pre-defined threshold, the SD flag instructs the calibration circuit to interrupt the calibration process.

8. The calibration apparatus of claim 3, wherein when the comparison result indicates that the SD indicator does not exceed the pre-defined threshold, the SD flag instructs the calibration circuit to resume or continue the calibration process.

9. A calibration method comprising:
performing a calibration process upon a time-interleaved analog-to-digital converter (TI-ADC) with a plurality of TI channels, comprising:
detecting and correcting mismatch between different TI channels of the TI-ADC;
setting a singularity detection (SD) flag by evaluating variation of statistical characteristics of an ADC input signal between different TI channels of the TI-ADC; and
controlling the calibration process according to the SD flag.

10. The calibration method of claim 9, wherein the calibration process is a blind calibration process.

11. The calibration method of claim 9, wherein setting the SD flag by evaluating variation of statistical characteristics of the ADC input signal between different TI channels of the TI-ADC comprises:
receiving a plurality of digital signals derived from outputs of the plurality of TI channels, respectively;
estimating a plurality of power indication values according to the plurality of digital signals, respectively;
performing a peak-to-peak value calculation operation according to the plurality of power indication values;
comparing a pre-defined threshold with an SD indicator derived from an output of the peak-to-peak value calculation operation to generate a comparison result; and
setting the SD flag according to the comparison result.

12. The calibration method of claim 11, wherein each of the plurality of power indication values is a mean power value.

13. The calibration method of claim 11, wherein each of the plurality of power indication values is a mean absolute value.

14. The calibration method of claim 11, wherein setting the SD flag by evaluating variation of statistical characteristics of the ADC input signal between different TI channels of the TI-ADC further comprises:
calculating a moving average value according to the output of the peak-to-peak value calculation operation; and
outputting the moving average value as the SD indicator.

15. The calibration method of claim 11, wherein setting the SD flag according to the comparison result comprises:
in response to the comparison result indicating that the SD indicator exceeds the pre-defined threshold, setting the SD flag to interrupt the calibration process.

16. The calibration method of claim 11, wherein setting the SD flag according to the comparison result comprises:
in response to the comparison result indicating that the SD indicator does not exceed the pre-defined threshold, setting the SD flag to resume or continue the calibration process.
